(19) United States
(12) Patent Application Publication
(10) Pub. No.: US 2013/0121515 A1
(43) Pub. Date: May 16, 2013

(54) LOUDSPEAKERS WITH POSITION TRACKING

(71) Applicants: Anthony Hooley, Cambridge (GB); Richard Topliss, Cambridge (GB)

(72) Inventors: Anthony Hooley, Cambridge (GB); Richard Topliss, Cambridge (GB)

(73) Assignee: CAMBRIDGE MECHATRONICS LIMITED, Cambridge (GB)

(21) Appl. No.: 13/640,987

(22) PCT Filed: Apr. 20, 2011
(86) PCT No.: PCT/GB2011/000609

§ 371 Date: Dec. 19, 2012

(30) Foreign Application Priority Data
Apr. 26, 2010 (GB) 1006933.4
Apr. 29, 2010 (GB) 1007104.1
Sep. 6, 2010 (GB) 1014769.2
Nov. 29, 2010 (GB) 1020147.3
Dec. 15, 2010 (GB) 1021250.4

(51) Int. Cl. H04R 5/02

(52) U.S. Cl. CPC H04R 5/02
USPC 381/307; 381/300

(57) ABSTRACT

The present invention combines a head-tracking system, for example a camera system typically used for user head and eye tracking, with a plurality of loudspeakers to as to enhance the audio experience of the user. The location of the user can be used to alter the audio signal sent to the plurality of loudspeakers to improve such functions as surround sound. In addition, the camera system can be used, when combined with an array of loudspeakers that can produce tight beams of sound, to direct different sound beams at different users, with virtually no crosstalk so as to allow users to experience different media from the same audio system, and which is tolerant of changed user positions. In addition, the camera system can aid setting up the array for real surround sound delivery, which bounces sound beams off wall. Cross-talk cancellation can additionally be used. The sound beams may represent 2-D or 3-D sound sources in real time. Sound beam parameters are adjusted to provide the listener with in impression of the 2-D or 3-D position and movement of sound-producing entities of audio-visual programme material in real-time. The beam parameters used include beam-direction, beam focal length, frequency response and gain. Such a Sound Projector producing a real-time representation of 3-D sound sources can be used alone or in conjunction with a video display, a television, a personal computer or a games console.

The present invention relates to audio devices and methods for providing better sound reproduction, especially stereo or surround sound reproduction, preferably without the need for headphones.

‘2D’ (two-dimensional) and more recently ‘3D’ (three-dimensional) visual displays are known in the art, and versions of the latter (some requiring special glasses to view) are now becoming commonplace in television-set and computer visual-display offerings by many manufacturers. The present invention can be used especially with 3D displays to help reinforce the 3D effect, but can also be used with all types of 2D and 3D visual displays.

Array loudspeakers such as the Digital Sound Projector (DSoP) are known in the art (e.g. see patents EP 1,224,037 and U.S. Pat. No. 7,577,260). These typically comprise an array of loudspeaker transducers each driven with a different audio signal. The array is configured to operate in a similar manner to a phased array, where the outputs of the different transducers in the array interfere with each other. If the audio signal sent to each transducer is suitably controlled, it is possible to use the loudspeaker array to produce multiple narrow beams of sound.

One way in which the beams may be used in a home theatre arrangement is to bounce the sound off various surfaces of the room so that different sound channels reach the users from different directions, thereby providing a real surround sound experience. The separate beams may be used to direct sounds at the user from different directions by bouncing them off walls, floors and ceilings, or other sound-reflective surfaces or objects.

In normal use of a DSoP for creating a surround-sound sensation, the front-channel signal is directed straight at the listening area (wherein are the listeners) with the beam focal-length set to a fixed distance chosen to optimise the even distribution of that channel's sound amongst the listeners (often this is best set at a negative focal length, i.e. giving a virtual focus positioned behind the transducer array); the front-left and front-right-channel signals are commonly directed to the listening area via a left and right wall-bounce (respectively), so that the dominant sounds from these channels reach the listeners from the direction of the walls, greatly enhancing the sense of separation of the left and right channels, and providing a wide spatial listening experience; the rear-left and rear-right channels are commonly bounced off the sidewalls (and where the DSoP allows for vertical beam-steering as well as horizontal beam-steering, off the ceiling too) and subsequently off the rear walls to finally reach the listening area from a direction opposite to the DSoP (i.e. from behind the listeners), to give a strong sense of “surround-sound”. In all of these situations it is usual that once set-up, the directions, gains, frequency responses and focal lengths of all channel sound beams are fixed for the duration of a listening session, unless the user actively intervenes to modify them manually (e.g. via a remote control).

It may be appreciated that for the use of the DSoP to produce effective surround sound, which requires bouncing sound beams off the walls of the room, it is highly desirable to know the dimensions of the room and the relative positions of both the DSoP and the users. Currently this can be achieved by either the user or installer manually adjusting the directions and focussing of the beams to achieve the desired effect. An alternative is to use a microphone positioned in the room and measure the sound received by the microphone as beams of sound are swept around the room. The information from such measurements allows an assessment of the room geometry, and the angles for best audio experience. This process can be termed ‘microphone based automatic set-up’ (MBAS) and is disclosed in European patent No. 1,584,217.

Another use of the beams is to project separate sound beams directly to each user in a home theatre set-up. This can be combined with splitting the display screen to project two or more separate programmes. In this way separate users can view and listen to different media. The narrow beams of sound mean that there is little crosstalk so the sound beamed to one user can be made virtually inaudible to another. This function can be termed ‘beam-to-me’.

Image analysis and segmentation and object identification processes are also known in the art, which when applied to video signals representative of a real (or virtual) 2D or 3D scene, are able to extract more or less in real-time, image features relating to one or more objects in the scene being viewed. These are nowadays for example found in video cameras able to identify one or more people (or perhaps just faces of people) in a scene, to identify the locations of those people (e.g. by displaying a surrounding-box on the camera's display-screen) and even in some cases to determine which of the people in the image are smiling.

The human ear/brain system determines the direction of incoming sounds by attending to the subtle differences between the signals arriving at the right and left ears, primarily the amplitude difference, the relative time-delay, and the differential spectral shaping. These effects are caused by the geometry and physical structure of the head—primarily because this places the two ear apertures at different positions in space, and with differential shadowing, absorbing and diffracting structures between the two ears and any source of sound. The differences in response between the two ears are summarised as a Head Related Transfer Function (HRTF), a function of frequency and angular position of sound source relative to some reference, e.g. straight ahead in the horizontal plane. It follows from the way this HRTF is defined, that if a source of sound is delivered to the region of each ear of a listener with a difference between the ear-signals identical to the HRTF for a particular soundsource direction THETA (a 3D ANGLE), then the listener will perceive the location of the sound as being from direction THETA, even though it might be delivered directly to the ears by, for example, headphones. Such HRTF-based sound delivery to both ears may be well described as 3D-sound, in the sense that if accurately done, the listener can perceive a complete 3D sound-scape, real or completely synthetic. Many ways of delivering HRTF-based 3D sound (hereinafter just 3DSound) are known in the art. As described above, the simplest is perhaps via headphones, though this is often inconvenient for the listener in practice, difficult at all if the listener is moving, and requires multiple sets of headphones for multiple listeners. Also, with headphones, if the listener moves her head then she will have an unsettling perception of the sound-field moving with her head, which breaks the spell and no longer sounds ‘real’. The one key advantage of headphone delivery of 3DSound is that it is simple to almost completely eliminate cross-talk between the two ear signals—one can precisely deliver the left signal to the left ear and the right signal to the right ear.

To avoid the practical issues inherent in delivering 3DSound to a listener or listeners with headphones, methods are known in the art for delivering 3DSound with two or more loudspeakers, remote from the listener. When this is done the principal new problem to be solved is the reduction of cross-talk between the two ear-signals, such that the left ear hears more or less just the left signal, and ditto for the right ear, even though both ears are now exposed to both loudspeakers. This problem and its solutions are generically known as Cross-Talk-Cancellation (XTC).

The present invention in one aspect makes use of head-tracking, eye-tacking and/or gaze tracking systems that may be incorporated into audio systems (such as a DSoP), PCs or Ns to improve the audio experience of users.

In one aspect the invention comprises an audio system comprising: a plurality of loudspeakers for emitting audio signals; and a head-tracking system; wherein said head-tracking system is configured to assess a head position in space of a listener; wherein the assessed position of the listener's head is used to alter the audio signals.

Optionally, said head-tracking system comprises one or more cameras combined with software algorithms.

Optionally, two or more separate directed sound beams are emitted by the plurality of loudspeakers.

Optionally, a video camera is used to detect the head position and the sound beams are directed accordingly.

Optionally, the head position of one or more listeners is tracked by the video camera in real time and the sound beams directed accordingly.

Optionally, one sound beam is directed towards the left ear of a listener and another sound beam is directed towards the right ear of a listener.

Optionally, the left directed beam is focussed at a distance corresponding to the distance of the listener's left ear from the loudspeakers and the right directed beam is focussed at a distance corresponding to the distance of the listener's right ear from the loudspeakers.

Optionally, a sound beam is focussed close to each of a listener's two ears, wherein the two sound beams are configured to reproduce stereo sound or, in conjunction with head-related-transfer-function processing, surround sound.

Optionally, a head related transfer function and/or psychoacoustic algorithms are used to deliver a virtual surround sound experience, and wherein the parameters of these algorithms are altered based on the measured user head position.

Optionally, the head related transfer function comprises parameters and the audio system is arranged to alter the parameters of the head related transfer function in real time.

Optionally, an array of loudspeakers is used with audio signals that interfere to produce a plurality of sound beams projected at different angles to the array, and wherein the angles of the beams are controlled using the head tracking system so as to direct the beams towards the ears of the one or more users so as to allow the beams to remain directed to the ears as the one or move users move.

In another aspect the invention comprises an audio system comprising: a plurality of loudspeakers for emitting audio signals; wherein two or more separate directed sound beams are emitted by the plurality of loudspeakers; wherein one sound beam is configured to be focussed at the left ear of a listener and another sound beam is configured to be focussed at the right ear of a listener.

Optionally, the plurality of loudspeakers are arranged in an array.

Optionally, stereo or surround sound is delivered to one or more listeners.

Optionally, the audio system is configured to direct further beams at additional listeners.

Optionally, a focus position of the two sound beams is moved in accordance with movements of the listener's head.

Optionally, cross talk cancellation is applied.

Optionally, each beam carries a different component of a 3D sound programme.

In a further aspect the invention comprises an audio system that comprises an array of multiple loudspeakers that can direct tight beams of sound in different directions and a head-tracking system which includes one or more cameras combined with software algorithms to assess head positions in space of one or more users of the system, wherein the positions of the one or more users' heads are used to alter the audio signals sent to each of the loudspeakers of the loudspeaker array, so that separate audio beams are directed to different users with little crosstalk between the beams, and where the directions of the beams are altered based on the measured positions of the users.

In a further aspect the invention comprises an audio system that comprises an array of multiple loudspeakers that can direct tight beams of sound in different directions and a camera recognition system which includes one or more cameras combined with software algorithms to assess features in the room, such as walls, wherein the assessment of the room geometry is used to determine the set up of different audio beams, typically the direction and focus of each beam allowing the beams to be appropriately bounced off the available walls and features of the room so as to deliver a real surround sound experience to the user or users.

In a further aspect the invention comprises a Sound Projector capable of producing multiple sound beams with a control system configured such that one or more of the beam parameters of beam angle, beam focal length, gain and frequency response are varied in real time in accordance with the 2D and 3D positions and movement of sound-sources in the programme material being reproduced.

Optionally, the Sound Projector is provided in conjunction with a visual display wherein the Sound Projector channel beam-settings for one or more of the several channel sound beams are dynamically modified in real-time in accordance with the spatial parameters of the video-signal driving the visual display.

Optionally, the spatial parameters are derived by a first spatial parameter processor means which analyses the video input signal and computes the spatial parameters from the video-signal in real-time.

Optionally, the spatial parameters are derived by a second spatial parameter processor means which analyses the audio input signal and computes the spatial parameters from the audio signal in real-time.

Optionally, the spatial parameters are derived by a spatial parameter processor means which analyses both the video and audio input signals and computes the spatial parameters on the basis of a combination of both of these signals.

Optionally, the channel beam-parameters are modified in real-time in accordance with meta-data provided alongside the video and/or audio input signal.

Optionally, the beam parameters of one or more beams are optimised for a close listening position.

Optionally, the distance of said listening position from the Sound Projector is of the same order of magnitude as the width of the Sound Projector.

Optionally, the Sound Projector subtends an angle greater than 20 degrees at said listening position.

Optionally, the beam focus position may be in front of or behind the plane of the Sound Projector in order to represent z-position of a sound-source in the programme material.

Optionally, the Sound Projector is used with a video display, a television, a personal computer or a games console.

A third aspect of the present invention is to use the camera system that is an inherent part of the head tracking system to assess the dimensions of the room, and the positions of users to calculate the optimum angles and focusing depths of beams to deliver a real surround sound experience. Such a system would replace MBAS and improve usability of the system.

The invention will now be further described, by way of non-limitative example only, with reference to the accompanying schematic drawings, in which:

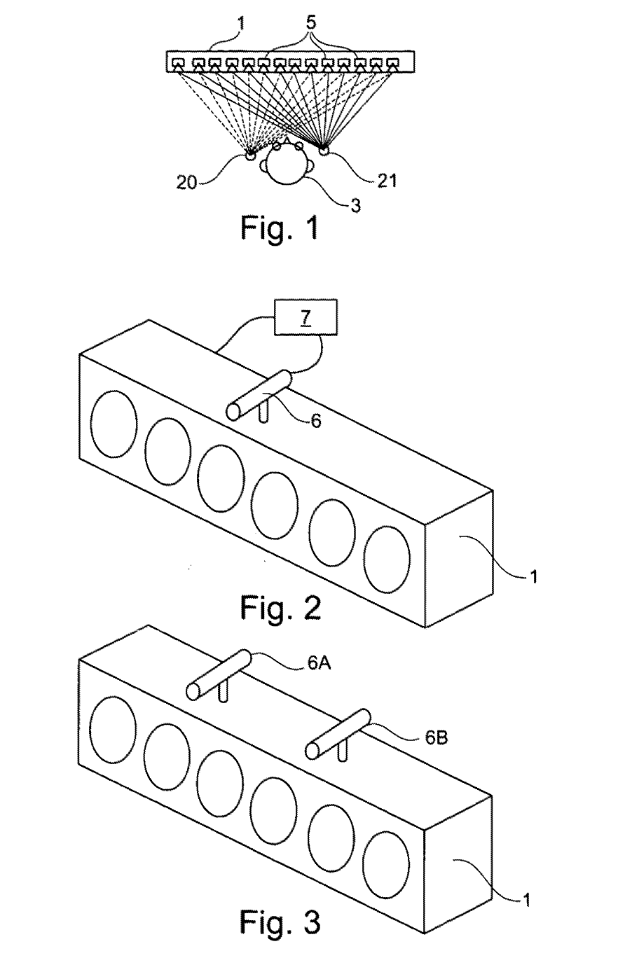

FIG. 1 shows a top view of a Sound Projector that is simultaneously directing two beams, one at each of a listener's two ears;

FIG. 2 is a perspective view of an audio apparatus comprising a horizontal Sound Projector and a camera used for head tracking;

FIG. 3 is a perspective view of an audio apparatus comprising a horizontal Sound Projector and two cameras used for precise head tracking;

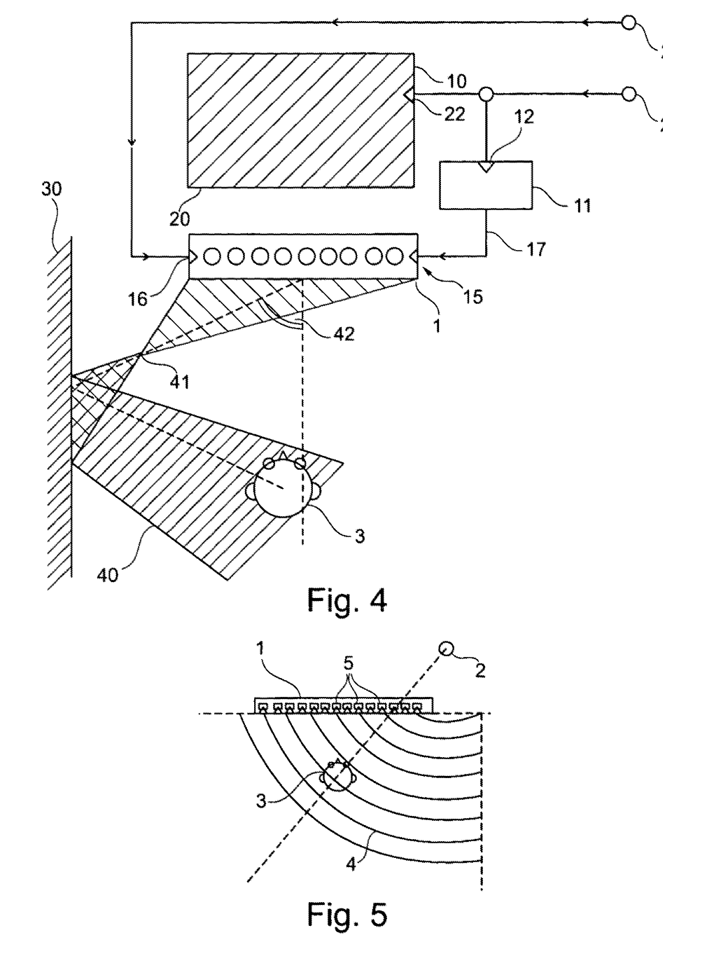

FIG. 4 shows apparatus for implementing a spatial parameter processor means; and

FIG. 5 shows a top view of a Sound Projector that is providing a listener 3 with a sound field having a virtual origin 2.

### SOUND DELIVERY

According to a first aspect of the present invention, an array loudspeaker is used instead of 2 or more discrete loudspeakers, to deliver sound, preferably 3Dsound, to a listener's ears, by directing two or more beams (each carrying different components of the sound) towards the listener. The overall size of the array loudspeaker is chosen such that it is able to produce reasonably directional beams over the most important band of frequencies for sound to be perceived by the listener, for example from say 200-300 Hz up to 5-10 KHz. So for example, a 1.27 m array (approx 50 inches—matched to the case size of a nominal 50-inch diagonal TV screen) might be expected to be able to produce a well-directed beam down to frequencies below 300 Hz. The experimentally measured 3 dB beam half-angle at a distance of ˜2 m is about 21 deg when unfocused, which is much less than the nearly 90 deg half-angle beam of a small single transducer loudspeaker. When focussed at ˜2 m in front of the array the half-angle beamwidth reduces to ˜15 deg. At 1 KHz the measured beam half-angle reduces to less than 7 deg when the beam is focussed at ˜2 m in front of the array. Clearly, with such narrow beamwidths the proportion of radiated sound from the array being diffusely spread around all the scattering surfaces in the listening room is greatly reduced over the small-discrete-loudspeaker case.

Preferably according to the present invention, the array loudspeaker is used to deliver sound or 3DSound to a listener, with the added feature that the beam or beams carrying information for the left ear are directed towards the left ear of the listener, and the beam or beams carrying information for the right ear are directed towards the right ear of the listener. Preferably, the beams are delivered to the ears as precisely as possible. In this way the relative intensity at each ear of beams intended for that ear are increased relative to the opposing ear. The net effect is improved discrimination of the desired signals at each ear.

The beam to each ear can be made to carry sound signals representative of what that ear would have heard in the original sound field that is to be reproduced for the listener. This can be achieved using a HRTF, to create 3Dsound. These signals are similar to those presented to the ears when reproducing surround sound over headphones. It is the differences between the two signals that allows the listener to infer multiply different sound sources around her head.

When wearing headphones there is little or no cross-talk between the channels (i.e. the right ear hears almost only the sounds intended for the right ear, and similarly for the left ear, because of the isolation between the ear provided by the headphones). When attempting to deliver these types of sound signals to a listener via a pair of standard loudspeakers a great deal of work has to be done to (partially) cancel the crosstalk effects, as the stereo loudspeakers by themselves deliver an almost similar amplitude of signal to each ear, and much compensation is required, relying on knowledge of Head-Related-Transfer-Functions (HRTF) and the listener's head position, prior to transmission of the sounds by the loudspeakers. However, using a DsoP it is possible to quite tightly focus (at least the higher frequency portion of the spectrum) a separate beam onto each ear (or in the vicinity of each ear), and for each such beam to carry suitably different signals to convey the required information about the entire sound field to be reproduced. The cross talk can be made quite small with a sufficiently sized DsoP array, above a given frequency. However at frequencies whose wavelengths are large compared to the inter-ear-spacing distance, only low-levels of separation are possible with this technique and the crosstalk will become larger.

Preferably, the beam or beams directed towards the left ear of the listener are also focussed at a distance from the array corresponding to the distance of the listener's left ear from the array, and the beam or beams directed towards the right ear of the listener are also focussed at a distance from the array corresponding to the distance of the listener's right ear from the array. Accordingly, the focal spot for each beam is in the vicinity of each respective ear of the user. In this way the relative intensity at each ear of beams intended for that ear are further increased relative to the opposing ear.

FIG. 1 shows a Sound Projector 1 comprising an array of acoustic transducers 5, sited close to a listener 3, with one sound beam directed and focussed to a focal point 20 very close to the left ear of the listener 3, and another sound beam directed and focussed to a focal point 21 very close to the right ear of the listener. Because of the significant difference of the intensity of the two beams at their respective own focal points relative to the same beam intensities at the other beam's focal points, good listener channel-separation may be achieved, so that the listener 3 dominantly hears the first beam with her left ear (it being very close to focal point 20), and dominantly hears the second beam with her right ear (it being very close to focal point 21). Thus if the programme material on these two beams is representative of what the listener would have heard in each ear were she wearing headphones, then stereo sounds, and full surround sound signals prepared using HRTF information may be delivered remotely to the listener, without wires.

For the sake of completeness it should be pointed out that in any of the above arrangements whereby two beams of sound are generated, either both directed towards the vicinity of the listener's ears, or more specifically, one directed to the vicinity of each of the listener's two ears (Left and Right), it is possible to generate these two beams from two quite separate array-loudspeakers, suitably positioned. If they are both primarily one-dimensional arrays, preferably aligned in the L-R direction (i.e. in a roughly horizontal plane with the arrays' axes directed towards the vicinity of the listener's ears), then they may be stacked vertically in order to position their effective source centres the appropriate horizontal distance apart (e.g. if the sum of half the length of each array is greater than the desired L-R source spacing), with their horizontal spacing chosen at will; otherwise, they may be positioned in roughly the same horizontal plane. Other than the elimination of the requirement to superpose the L and R signals in the one array, this arrangement of two separate arrays appears to have no specific advantages, and several practical disadvantages, including increased size and cost.

Where the listener's head is relatively stationary with respect to the DsoP, the two beam-focal-points may be fixed in space once the system has been set-up for that particular user position. Such a situation may arise for example in the case of a DsoP used with a PC where the listener is usually seated directly in front of the PC. Another such situation is in a vehicle, e.g. a car, where the listener's position is more or less fixed by the seat-position. In this latter case the user may adjust her seat to change her position, but in this case, the seat adjusting mechanism may be used to feed information about the likely new position of the listener's head by interrogation of the seat-adjustment system and so the two beam-focal-point positions may be automatically adjusted to track her movement with the seat changes.

### Head-Tracking

However, in other cases where the listener's head position may change unpredictably, or where it is otherwise relatively unknown at all, a camera (perhaps usefully mounted in the DsoP but in any case, in a position where it can clearly see the listener's head) is used to image the listener's head, and image analysis software can be used to determine the identity and position of the image of the listener's head within the camera image frame. Knowing the geometry, position and pointing direction of the camera, and the approximate size of a human head it is then possible to estimate the 3D coordinates of the listener's head (relative to the camera, and thus relative to the DsoP) and so to automatically direct the two beams appropriately close respectively to the listener's two ears. Should the listener move then the head-tracking system can detect the move and compute new beam focal point positions, and so track the listener's head.

Accordingly, a head-tracking system, preferably comprising a video camera, is used in a second aspect of the present invention to view the listening room at least in the region where the listeners are likely to be situated. The system is able to identify in real or near-real time from the captured video image frames the position relative to the loudspeakers of one or more of the listeners. For one or more of each such position-tracked listeners, the audio system can suitably adjust the direction of one or more beams used to deliver sound to that listener such that as and when that listener changes her position in the room, the associated beam(s) are held in more or less the same position relative to the listener's head. This development can be used to ensure that the listener always receives the correct sound information. When two beams are used, this can appropriately optimize the cross-talk cancellation at that listener's head without the need for complex algorithms or the need to use headphones. As such, the invention is able to provide stereo or surround sound to one or more listeners, without needing to use headphones, and without there being only one small “sweet spot” in the room. In effect, the invention can provide each listener with her own individual “sweet spot” that moves when the listener moves. Accordingly, an excellent effect can be obtained that has not hitherto been possible.

Head tracking can also be applied to PC applications, where there can often be several characteristics and constraints. Firstly, the single user is typically located around 60 cm from the screen, with their head centrally positioned. Secondly, the location of walls behind the user is highly uncertain and using the room walls to bounce sound may be impractical. Thirdly, audio products for PCs are extremely price sensitive, meaning that there is strong price pressure to avoid using many transducers in the array. Fourthly, the main competition for producing surround sound in such applications is the use of psycho-acoustic algorithms to produce ‘virtual surround sound’ (virtualiser). Such systems make use of knowledge about how the user's brain interprets audio input to the two ears to locate a sound source in 3D space. In particular, such algorithms make use of ‘head related transfer functions’, which model how the sound from different directions is affected by the user's head, and what the delays are and other changes to the audio signals received by the two ears for sounds coming from different directions.

As standard, such virtualiser systems merely make use of the standard stereo speakers used with most PC systems that are typically located one on either side of the display screen. Such virtualiser algorithms require the user to occupy a very tight region between the speakers. When the user moves their head away from being centrally located, the surround sound virtual audio experience is lost.

At a basic level, one aspect of the present invention is to alter the parameters of the virtualiser algorithms based on the measured information about the position of the user's head in 3D space as determined by the head tracking system.

The invention preferably uses a DSoP array configured to produce two narrow beams of sound, one directed to each ear of the user. As the user's head moves, the beam directions are also altered so as to maintain the direction of the beams on each ear. The audio signal applied to each beam may be processed with psycho-acoustic algorithms to deliver a virtual surround sound affect. However the use of the DSoP array, when combined with the head tracking system means that there is a dynamically adjusting and moving ‘sweet spot’ for experiencing surround sound. In addition to directing the sound beams, as above, it is also possible to alter, in real time, the parameters of the virtual surround sound algorithms to account for the different orientations of the user's head. With such a system, it is possible to reduce the size and complexity of the DSoP array, as the functionality is now limited to projecting two beams of sound that need to be separated by approximately the width of the user's head. This can help reduce the cost of the array.

FIG. 2 shows an audio system comprising a Sound Projector 1 having mounted thereon a camera 6. In this example, the Sound Projector is a horizontally extending line array that is capable of beaming within a horizontal plane. The camera 6 is mounted on the sound projector so as to have a field of view that generally includes all the likely listening positions. The camera 6 and Sound Projector 5 are shown in FIG. 2 to be schematically connected to a processor 7 that can interpret the images from the camera 6, determine listener head or ear positions and provide control signals to the Sound Projector 5 that cause different beams to be directed to different users, or that cause each user to receive different beams to their left and right ears respectively. Each user can receive the same programme, in which case all the left ear beams carry the same information and all the right ear beams carry the same information or the users can receive different programmes, in which case the left ear beams may carry information different to one another and ditto for the right ear beams. The processor 7 may be integrated into either the camera 6 or the Sound Projector 5 and, indeed, the camera 6 may be integrated into the Sound Projector 5 to create a one-box solution.

A further aspect of the invention relates to the use of the system in home theatre set-ups, where users are typically positioned much further from the screen, and multiple users may be using the screen. A similar function as described above may be used to improve the performance of the beam-to-me function, by altering the angle of the beam projected to each user depending on the position of the user's head.

Depending on the complexity and performance of the array, it can be possible, even at extended distance, to be able to send separate beams to each ear of the user, and combine the DSoP with a virtualiser system to allow virtual surround sound.

According to a further aspect of the invention, another completely independent set of two or more beams is used to deliver sound or 3DSound to one or more additional listeners, by directing each additional set of beams towards the respective additional listener in a manner as described above. Because of the linearity of an array loudspeaker additional beams are largely unaffected by the presence of other the beams so long as the total radiated power remains within the nominally linear capabilities of each of the transducer channels. Furthermore, because the set of beams for each listener can be relatively localised to the vicinity of that listener by suitably directing and focusing the beams towards that listener, and by suitable sizing of the loudspeaker array for the frequencies/wavelengths of interest to achieve adequate beam directivity (i.e. suitably narrow beam angles), the additional beams will not cause unacceptable additional crosstalk to the other listener(s).

FIG. 3 shows an embodiment where the head-tracking system comprises two cameras 6a, 6b. The cameras 6a, 6b are spaced apart horizontally and both image the expected listening position. The separation of the cameras allows a 3D image to be reconstructed, and also allows a distance of a listener's head from the array to be calculated. This can then be used to more precisely focus the beams at the location of the listener's ears.

### Spatial Parameter Identification

In a third aspect of the present invention, a DSoP is used in conjunction with a visual display, and the channel settings (e.g. beam direction, beam focal-length, channel frequency-response) for one or more of the several channel sound beams are dynamically modified in (or approximately in) real-time in accordance with the spatial parameters of the video signal driving the visual display. By spatial parameters is meant information inherent in the video signal that relates to the frame-by-frame positions in space (of the real or virtual scene depicted by the video display as a result of the video signal) of one or more objects in that scene.

For the purposes of discussion (only) we define a set of Cartesian axes to describe scene object-locations as follows: X-axis is positive, left to right as seen on the display screen; Y axis is positive down to up as seen on the display screen; Z-axis is positive coming perpendicularly out of the screen towards the viewer. For example, if the dominant object in one scene is a vehicle travelling largely towards the camera viewing position, then its Z-axis position will be increasing positive, and if it is moving slightly left-to right and top to bottom in so doing, its X-axis position will be increasing positive and its Y-axis position decreasing (negative).

In this third aspect of the invention sounds emitted by one or more of the DSoP channels can have their beam angles and/or focal lengths and/or gains and/or channel frequency-responses (or other “channel settings”) dynamically modified during the course of display of a visual scene on the visual-display, in accordance with the variation of the X and/or Y and/or Z axis positions of one or more objects depicted in the scene in real-time (or near real-time) and in a correlated manner. In this way, the viewer's (=listener's) perception of the movement (and dynamic location) of said object(s) will be heightened by the correlated change of perceptions she receives from the combined DsoP/visual-display outputs (sound and vision). It is to be understood that herein reference to DSoP means any kind of array of (3 or more) acoustical transducers wherein (at least) the signal delay to 2 or more of the transducers may be altered in real-time, in order to modify the overall DSoP acoustic beam radiation pattern, and there is no necessity to additionally bounce any of the DSoP beams off walls or other objects, for the purposes of this invention, although so doing may produce additional beneficial acoustic effects as in normal use of DsoP for surround-sound generation.

In FIG. 4, a Sound Projector 1 receives an audio input signal 26 at its audio input port 16 and sound-beam control-parameter-information 17 at its beam-control input 15 from a source 11 which in turn derives its output in real-time from a video input signal 21 applied to its video-input port 12. A visual display 10 receives the same video input signal 21 at its video input port 22. A listener 3 placed somewhere in front of the Sound Projector 1 hears a beam of sound 40, possibly bounced off a reflecting surface 30. The beam of sound is focussed at position 41 and steered at an angle 42 off the Sound Projector axis. Position 41 and angle 47 are varied in real time in accordance with video programme material by application of the sound-beam control-parameter-information 17.

The visual display may be a standard 2D display or a more advanced 3D display. The video signal in either case may be a 2D signal or an enhanced 3D signal (although in this case a 2D display will not be able to explicitly display the third (Z) dimension). It is important to recognise that 2D and 3D spatial parameters are inherent in both 2D and 3D video signals (if this were not the case then viewers looking at a 2D display would have no sense of depth at all, which is simply not the case). Human viewers normally infer depth even in 2D images by means of mostly unconscious analysis of a multitude of visual cues including object-image (relative) size, object occlusion, haze, and context, as well as perhaps also by non-visual cues provided by any accompanying sound track. These latter include Doppler effects (objects in the scene emitting sounds and moving towards or away from the microphone used to record the sound will suffer pitch change, generally approaching objects having a relative increase in pitch), sound loudness changes (objects emitting sounds moving towards and away from the microphone will suffer amplitude changes, generally an overall diminishing of level with increasing distance), and sound frequency response changes (objects emitting sounds moving towards and away from the microphone will suffer frequency response changes, generally a relative lowering of high-frequency content with distance). Clearly in a 3D signal intended for a 3D visual display there is additional explicit 3D information (e.g. in the form of left- and right-image video signals or at least L-R signal differences) and a viewer is not required to perform quite as much visual-cue analysis with such a 3D display in order to achieve a sense of visual depth. Nevertheless, such analysis will still be performed by the viewer and so long as it correlates well with the stereoscopic depth information encoded in the differences in the left- and right-image signals, an enhanced sense of depth will be produced.

In this aspect of the invention a spatial parameter processor means may be provided to analyse the audio signal and/or video signal (either 2D or 3D video signal) and to extract from those signals, in real-time (i.e. with a delay small compared to the dynamics of the scene changes, so e.g. on time scales of milliseconds to fractions of a second, rather than seconds) some of the same type of spatial information that a viewer would extract from listening to it on a sound reproduction system and/or viewing the scene on a visual display, including some or all of the X, Y, Z coordinates of one or more objects in the scene, and in particular, those scene objects likely responsible for some of the sounds on the sound-track. In the case where a visual display is provided, it is useful that parameters so extracted are more or less of the same type and magnitude of spatial information that a viewer extracts, as otherwise the changes to the DSoP beam parameters, made on the basis of these extracted spatial parameters, will not correlate well with the viewer's own visual experience, and will instead cause a discomforting, rather than a heightened viewing/listening experience, unless of course this is the intended effect. In the case that a DSoP only is provided (i.e. no visual display) then modifications to the various channel beam parameters may be made more freely, as whatever spatial sensations these produce in the listener cannot clash with any visually perceived visual sensations, as there are none in this case. Thus in this latter case more extreme or less “accurate” processing may be applied to heighten spatial (sound) sensation with less likelihood of producing listener discomfort.

For example, such a spatial parameter processor can be simply derived from the type of processor described herein above, already commonly found in video cameras (including domestic High-Definition (HD) video cameras) which is able in more or less real-time to identify and track people's faces and display on the camera's visual-display, rectangles bounding the faces. The size of such bounding rectangles gives a first estimate of relative face Z-distance (most adult faces are very similar in absolute size), and the centre of gravity of the rectangle gives a good estimate of face X, Y centre coordinates in the scene. Thus using changes in such parameters for each tracked-face to change the beam-parameters of any DSoP beam creating sounds relating to that face could give a heightened sense of object movement. Clearly, a processor specifically designed for the current purpose could do a better job than an existing camera “people/face-spotter”, most particularly in the areas of determining dominant moving objects, and objects most likely to be producing specific sounds (and this task could be enhanced by correlating spatial changes within the sound field determined from an analysis of Front, Left, Right, Rear-Left, Rear-Right etc channels, taken in conjunction with correlations of these with spatial changes detected in the visual image), but this example is raised to make it clear that even existing state of the art commercially available low-cost domestic-segment products already have some of the capability required to drive a system like the present invention.

In a further aspect of the present invention, a DsoP is used most usefully but not exclusively in conjunction with a visual display, and the channel-settings (including one or more of beam direction, focal length, channel-gain, channel frequency-response) for one or more of the several channel sound-beams are modified in accordance with meta-data embedded in, or provided alongside the audio and/or video signal driving the audio system and/or visual display. In this case such meta-data explicitly describes spatial aspects of the (visual) scene related to the audio, that may also be depicted with any visual signal, and it is not necessary to provide a processor means (e.g. SPP) explicitly to extract spatial parameters from the audio and/or video-signals per se. Nonetheless, some processing of the meta-data itself may still be required in order to produce control parameters directly applicable to the several beams of the DSoP, in order to create the desired correlation of sound-field changes with the original visual scene and thus any video signal provided.

Although there is no universal standard for embedding such meta-data in broadcast radio or television signals, and as yet, in CD/DVD/Blu-ray disc recordings either, an immediately available source of suitable programme material can be found in computer games, wherein the computer program always “knows” where very object is (it is, after all, generating all such “virtual” objects), which makes the additional generation of such meta-data relatively easy to add on to any existing game.

It is also possible to use a system with embedded meta-data in the absence of a visual display, where the enhanced experience is produced by modifying the DSoP beam parameters in accordance with the extracted spatial information parameters (from any or all of the visual signals, the audio signals, and any meta-data) so that the reproduced sound field alone gives additional 2D and/or 3D spatial cues to the listener. Furthermore, it may be advantageous to use such a system even in the absence of a video signal, in the case that a spatial parameter processor is able to derive useful spatial parameters purely from an analysis of the multi-channel sound-signal alone, or in combination with or solely from the use of, meta-data included as part of or with the sound signal. Such a system might significantly enhance the user experience of radio programmes, as well as recorded music and other audio material.

In these aspects of the current invention it is necessary to determine how to modify the various DSoP beam channel parameters, in order to provide an enhanced spatial viewing and/or listening experience, given that scene spatial parameters (relating to objects depicted in the scene, and their changes) are available, either by virtue of provision of an spatial parameter processor, or more directly from meta-data related to the sound and/or visual channel information, or both.

A channel's sound-beam emission angles (the up/down angle and the left/right angle of the beam relative to the normal to the DSoP's front-face, hereinafter altitude and azimuth) may be modified in accordance with Scene Spatial Parameters (SSP) to directly modify the listener's perceived location of that channel. This applies to any channel beam that reaches the listener predominantly via one or more room surface bounces (reflections), so typically, e.g. left- and right-front, left- and right-rear, height channels, ceiling channels, etc., in the now conventional mode of use of the DSoP for surround-sound reproduction. For each of these cases there is a direct relationship between the channel's perceived source angular coordinates (i.e. the listener-centric source coordinate angles), and the channel beam's altitude/azimuth (alt/az) as emitted.

For example, for the Left-Front beam, increasing the azimuth angle (bending the beam closer to the front surface of the DSoP) moves the left-wall bounce location closer to the front of the room, which in turn causes the angular location of the channel sensed by the listener to move further towards the front of the room so that in turn the sound source location is perceived to become closer to the centre of the Sound Projector (|X| decreases). Note however that this effect occurs over a greater angular range to the extent that the wall reflection is to some extent diffuse. If only specular reflection occurs (perfectly smooth bounce points) then perceived source movement can only occur within the range allowed by the finite width of the sound projector, which is not a point source, and whose sound-image as perceived by the listener, reflected in the wall, is of finite extent. Thus flexibility in the range of availability of movement, is enhanced by the provision of wider DSoPs.

Similarly, increasing the altitude of the emitted Left-Front beam raises the bounce point on the left wall, and to the extent that reflection is diffuse and that the DSoP has vertical extent, the perceived sound location (again the sound-image of the DSoP reflected in the wall) will move upwards.

A channel's beam focal-length may be adjusted to modify the convergence angle of the beam as perceived by the listener, which in normal situations is correlated with perceived source-distance. However, for listener-distances significantly greater than DsoP width (a/or height in the case of 2D DsoP) the range of achievable convergence angles is small. A finite sound source (e.g. a motor-car) as directly perceived by a listener close to, will subtend a relatively wide angle at the listener. However, even were the radiation from the full-extent of the car to be in-phase (phase coherent) there would be at most an approximate plane-wave reaching the listener. For a smaller sound source (or a dominant one, such as the engine or exhaust) the wave field emitted approximates to a set of concentric circles centred on the source, with the radius of curvature at the listening position then becoming smaller as the source approaches the listener. So with a DSoP, to make a sound appear to be closer to the listener while holding the beam intensity constant at the listener's position, the beam focus should be brought in towards the DsoP to produce the minimum radius of curvature at the listener—this condition is achieved when the focal length is approximately half the beam path-length from the DsoP to the listener, at which point the sound is perceived as emanating from the focal point position as this is the centre of curvature of the received wave field. When focussed directly on the listener's location, the sound arrives converging onto the listener who is now the centre of curvature.

A channel's gain may be adjusted inversely in proportion to the source distance to give a sense of that distance. This is obviously the case as constant level sources sound louder as they move closer.

Finally, a channel's frequency response can be modified to give a sense of distance, as high frequency sounds are more easily absorbed, reflected and refracted (or more generally, diffused), so that the further away a source then the relatively more reduced are the higher-frequency components of its spectrum. Thus to emphasise the distance of a sound source a filter with, e.g. top-cut proportional to distance, could be provided.

In the situation where the listener is close to the DsoP (e.g. a distance away comparable to the width of the Sound Projector), then the transducer array will subtend a significant angle at the listener, in one, or two, directions depending on whether the Sound Projector is a 1D or 2D array. In this Close-Listening configuration, which is more typically found in e.g. personal computer (PC) use where the DsoP is typically mounted more or less in the plane of the display screen or even integrated with the screen, and also for example, in automotive applications where the DsoP may be mounted above the windscreen or within the dashboard, then another mode of operation for 3D sound is possible. In these situations the listener is mostly looking in the general direction of the DsoP, which by virtue of its length and proximity, subtends a significant angle at the listener.

In a further aspect of the present invention, if a single sound beam is focussed behind the plane of the transducers (i.e. a negative focal length, or virtual focus) and the beam directed at a chosen angle, then the listener will be able to perceptually locate its position in X (i.e. Left to Right) (and Y for a 2D DsoP array, and thus from Bottom to Top) as well as in Z (apparent distance from the user), and these position coordinates may be varied in real-time simply by varying the beam angle and beam focal-length. The virtual source at the virtual focal position will cause the DsoP to emit approximately cylindrical or spherical waves centred on the virtual source, and the structure of the sound waves thus created will cause the listener to perceive the position of the source of sound she hears to be at the virtual focus position. Multiple simultaneous beams each with their own distinct channel programme material and beam steering angle and focal length can thus place multiple different (virtual) sources in multiple different locations relative to the user (all of which may be time varying if desired). This capability of the DsoP is able to provide a highly configurable and controllable 3D sound-scape for the listener, in a way simply not possible with conventional surround sound speakers, and especially with simple stereo speakers.

FIG. 5 shows a Sound Projector 1 comprising an array of acoustic transducers 5, sited close to a listener 3, with a sound beam directed and focussed so as to produce a virtual focal point 2. The effect is to cause the Sound Projector 1 to emit approximately cylindrical (or spherical) waves 4 which the listener 3 then perceives as originating from point 2, to her right and behind the Sound Projector 1.

This aspect of the invention may be used in conjunction with an SPP as described above, or with meta-data as also described above, and in either case the sound positional parameters so derived may be used to control the beam parameters of one or more of the multiple sources created in the Close-Listening position, as previously described.

The same Close-Listening configuration can be achieved to some extent also in cinemas (movie theatres) if a DsoP is provided covering a substantial width of the projection screen (and in 2D if the DsoP also covers a substantial portion of the height of the screen also. Close-Listening would be possible for cinema customers seated in the front few rows (the number of rows where it would work well being determined by the total width of the screen and the width of the DsoP). However, were the DsoP array to be continued beyond the width of the screen, and possibly also thereafter continued from the screen along the side-walls of the cinema along some or all of the sides of the space where the cinema-goers are seated, then the Close-Listening 3D effect could in principle be extended to as many of the cinema seating rows as desired. There is no fundamental requirement that the DsoP transducer array need all be in a single plane. With the coming popularity of 3D movies, adding a long (wide) and possibly “wrap-around” DsoP would allow the provision of true 3D sound to the 3D cinema viewing experience.

It ought to be noted also that a “wrap-around” DsoP configuration as described above for cinemas, may also be conveniently provided in automotive applications where a vehicle cabin provides an ideal space for such a device to provide full 3D surround to the vehicle's occupants. Plausibly, DsoP side-extensions for a PC could also be provided to extend the 3D-sound angle capability of a screen-plane DsoP installation.

1. An audio system comprising:
a plurality of loudspeakers for emitting audio signals; and
a head-tracking system;
wherein said head-tracking system is configured to assess a head position in space of a listener;
wherein the assessed position of the listener's head is used to alter the audio signals.

2. The audio system of claim 1, wherein said head-tracking system comprises one or more cameras combined with software algorithms.

3. The audio system of claim 1, wherein two or more separate directed sound beams are emitted by the plurality of loudspeakers.

4. The audio system of claim 3, wherein a video camera is used to detect the head position of one or more listeners in real time and the sound beams are directed accordingly.

5. (canceled)

6. The audio system of claim 3, wherein one sound beam is directed towards the left ear of a listener and another sound beam is directed towards the right ear of a listener.

7. The audio system of claim 6, wherein the left directed beam is focussed at a distance corresponding to the distance of the listener's left ear from the loudspeakers and the right directed beam is focussed at a distance corresponding to the distance of the listener's right ear from the loudspeakers.

8. The audio system of claim 7, wherein the two sound beams are configured to reproduce stereo sound or, in conjunction with head-related-transfer-function processing, surround sound.

9. The audio system of claim 1, wherein a head related transfer function and/or psychoacoustic algorithms are used to deliver a virtual surround sound experience, and wherein the parameters of these algorithms are altered based on the measured user head position.

10. The audio system of claim 9, wherein the head related transfer function comprises parameters and the audio system is arranged to alter the parameters of the head related transfer function in real time.

11. The audio system of claim 1, wherein an array of loudspeakers is used with audio signals that interfere to produce a plurality of sound beams projected at different angles to the array, and wherein the angles of the beams are controlled using the head tracking system so as to direct the beams towards the ears of the one or more users so as to allow the beams to remain directed to the ears as the one or move users move.

12. An audio system comprising:
a plurality of loudspeakers for emitting audio signals;
wherein two or more separate directed sound beams are emitted by the plurality of loudspeakers;
wherein one sound beam is configured to be focussed at the left ear of a listener and another sound beam is configured to be focussed at the right ear of a listener.

13. The audio system of claim 12, wherein the plurality of loudspeakers are arranged in an array.

14. The audio system of claim 12, wherein stereo or surround sound is delivered to one or more listeners.

15. The audio system of claim 12, comprising further beams directed at additional listeners.

16. The audio system of claim 12, wherein a focus position of the two sound beams is moved in accordance with movements of the listener's head.

17. The audio system of claim 12, wherein cross talk cancellation is applied.

18. The audio system of claim 12, wherein each beam carries a different component of a 3D sound programme.

19. An audio system that comprises an array of multiple loudspeakers that can direct tight beams of sound in different directions and a head-tracking system which includes one or more cameras combined with software algorithms to assess head positions in space of one or more users of the system, wherein the positions of the one or more users' heads are used to alter the audio signals sent to each of the loudspeakers of the loudspeaker array, so that separate audio beams are directed to different users with little crosstalk between the beams, and where the directions of the beams are altered based on the measured positions of the users.

20. An audio system that comprises an array of multiple loudspeakers that can direct tight beams of sound in different directions and a camera recognition system which includes one or more cameras combined with software algorithms to assess features in the room, such as walls, wherein the assessment of the room geometry is used to determine the set up of different audio beams, typically the direction and focus of each beam allowing the beams to be appropriately bounced off the available walls and features of the room so as to deliver a real surround sound experience to the user or users.

21. A Sound Projector capable of producing multiple sound beams with a control system configured such that one or more of the beam parameters of beam angle, beam focal length, gain and frequency response are varied in real time in accordance with the 2D and 3D positions and movement of sound-sources in the programme material being reproduced.

22. (canceled)

23. (canceled)

24. (canceled)

25. (canceled)

26. (canceled)

27. (canceled)

28. (canceled)

29. (canceled)

30. (canceled)

31. The audio system of claim 1, used with a video display, a television, a personal computer or a games console.

32. The audio system of claim 12 used with a video display, a television, a personal computer or a games console.

33. The audio system of claim 19 used with a video display, a television, a personal computer or a games console.

34. The audio system of claim 20 used with a video display, a television, a personal computer or a games console.

35. The Sound Projector of claim 21 used with a video display, a television, a personal computer or a games console.
